(19) United States
(12) Patent Application Publication
(10) Pub. No.: US 2009/0133552 A1
(43) Pub. Date: May 28, 2009

(54) FOOD PRODUCT SLICER AND ASSOCIATED GAUGE PLATE ADJUSTMENT SYSTEM

(75) Inventor: Douglas J. McGuffin-Noll, Westerville, OH (US)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 12/281,513

(22) PCT Filed: Mar. 7, 2007
(86) PCT No.: PCT/US2007/063441

§ 371 Date: Sep. 3, 2008

Related U.S. Application Data
(60) Provisional application No. 60/780,424, filed on Mar. 8, 2006.

(51) Int. Cl. B26D 7/06; B26D 5/20

(52) U.S. Cl. 83/42; 83/713; 83/730; 83/412; 83/225

(57) ABSTRACT

A food product slicer includes a base and a knife mounted for rotation relative to the base. A carriage assembly is mounted to the base for reciprocal movement back and forth past a cutting edge of the knife. An adjustable gauge plate (70) is mounted for movement between a closed position that prevents slicing and multiple open positions that permit slicing at respective thicknesses. A handle (74) is mounted to the base for changing the gauge plate position. The handle is connected to move a cam member (128) internal of the base. The cam member is operatively connected to move the gauge plate through a cam follower (132, 134). A gauge plate adjustment system for setting an orientation of the gauge plate relative to the knife when the gauge plate is in the closed position includes structure for holding the handle, cam member and cam follower in respective, set positions while the orientation of the gauge plate relative to the knife is set.

### CROSS-REFERENCES

This application claims the benefit of U.S. provisional application Ser. No. 60/780,424, filed Mar. 8, 2006.

### TECHNICAL FIELD

This application relates generally to food product slicers of the type commonly used to slice bulk food products and, more specifically, to a system for adjusting an orientation and position of a gauge plate of a food product slicer.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. The gauge plate is situated along the edge of the knife toward the front of a slicing stroke and is laterally movable with respect to the knife for determining the thickness of the slices to be cut. A mechanism such as an adjustment knob for setting a spacing between the plane of the gauge plate surface and the plane of the plane of the knife edge for the purpose of slicing is also typically provided so that operators can select a thickness of slices to be produced. Movement of the gauge plate is generally a linear movement of the plane of the gauge plate relative to the plane of the knife edge. Thus, movement of the gauge plate handle can be considered to move the gauge plate in a manner to make slice thickness adjustments.

To achieve high quality product slices the gauge plate should, preferably, be initially mounted on the base of the slicer with its edge plane generally parallel to the plane defined by the cutting edge of the knife and such that the edge of the gauge plate is generally flush with the edge of the slicer knife when the gauge plate handle is moved to its zero position (i.e., the position defining the closed condition of the gauge plate when no slices can be cut). Such positioning can be difficult to achieve due to the need to set the position between the gauge plate relative to 6 degrees of relative motion, x-plane, y-plane, and z-plane and rotational movement about x, y, and z axes as well (see FIG. 4). In this regard, positioning of the gauge plate relative to the six degrees of freedom can be considered to move the gauge plate in a manner that defines the zero orientation of the gauge plate relative to the slicer knife.

It would be desirable to provide a gauge plate adjustment mechanism that facilitates repeatability within a machine as to slice thickness, and that also provides repeatability from machine to machine as to slice thickness.

### SUMMARY

In one aspect, a food product slicer includes a base and a knife mounted for rotation relative to the base. A carriage assembly is mounted to the base for reciprocal movement back and forth past a cutting edge of the knife. An adjustable gauge plate is mounted for movement between a closed position that prevents slicing and multiple open positions that permit slicing at respective thicknesses. A handle is mounted to the base for changing the gauge plate position. The handle is connected to move a cam member internal of the base. The cam member is operatively connected to move the gauge plate through a cam follower. A gauge plate adjustment system for setting an orientation of the gauge plate relative to the knife when the gauge plate is in the closed position includes structure for holding the handle, cam member and cam follower in respective, set positions while the orientation of the gauge plate relative to the knife is set.

In another aspect, a method of setting an orientation of a gauge plate of a food product slicer is provided. The food product slicer includes a handle for varying position of the gauge plate relative to a slicer knife to vary slice thickness. The handle is linked to the gauge plate through a cam arrangement including a cam member and cam follower. The method involves the steps of: moving the cam member to a set position; locking the cam member into the set position and locking the cam follower into a corresponding set position; adjusting position of the gauge plate with respect to the slicer knife and relative to six degrees of freedom; and unlocking the cam member and the cam follower to permit slice thickness adjustment via movement of the cam member.

### BRIEF DESCRIPTION OF DRAWINGS

FIG. 1 is a right side elevation of a slicer;

FIG. 2 is a perspective view of a gauge plate system;

FIG. 3 is a partially exploded view of the gauge plate system;

FIG. 4 is another exploded view of the gauge plate system;

FIG. 5 is an assembled elevation view of the gauge plate system; and

FIG. 6 is another exploded view of the gauge plate system.

### DETAILED DESCRIPTION

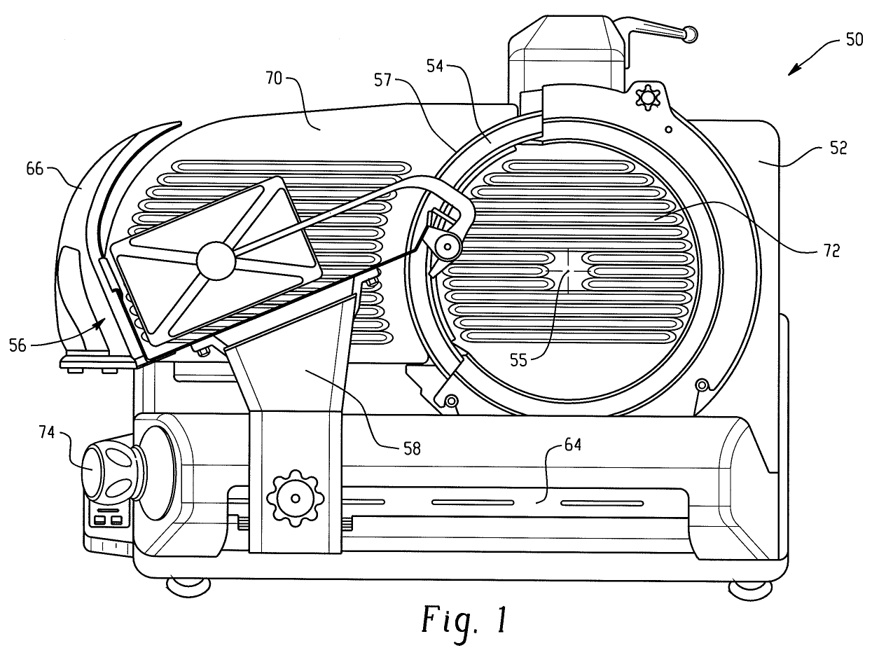

Referring to FIG. 1, a food product slicer 50 includes a housing or base 52 and a circular, motor-driven slicing knife 54 that is mounted to the housing for rotation about an axis 55. The left side of FIG. 1 is generally referred to as the front side of the slicer (which is where an operator stands for slicing), the right side of FIG. 1 is generally referred to as the rear side of the slicer and FIG. 1 depicts a right side view of the slicer. A food product can be supported on a manually operable food carriage 56 which moves the food product to be sliced past the cutting edge 57 of the rotating slicing knife 54. The food carriage 56 reciprocates from left to right relative to FIG. 1, along a linear path so that the lower end of the bulk food product slides along the surface of the gauge plate 70, is cut by the knife 54 and then slides along a knife cover plate 72. Food carriage 56 includes a tray mounted on a tray arm 58 that orients the food carriage tray at the appropriate angle (typically perpendicular) to the cutting edge plane. The food carriage reciprocates in a slot 64 at a lower portion of the housing 52 and a handle 66 is mounted to the food carriage 56. The handle is graspable by a user and can be used to manually move the food carriage. The carriage may also be automatically driven (e.g., as by a motor drive or other prime mover). A handle or knob 74 for adjusting the gauge plate to control slice thickness is also shown.

Repeatability of slice thickness is the control of slice thickness within a similar product, for example, if a particular machine slices ham at index setting of 4, on the adjustment knob, and that thickness is desirable, the next time a customer comes back to have more ham sliced and that if the index is set on 4 it will cut the same thickness. This theory will also apply from machine to machine repeatability. Prior techniques provided repeatability within a certain degree but not as consistent as desired. The machine to machine repeatability was generally not present.

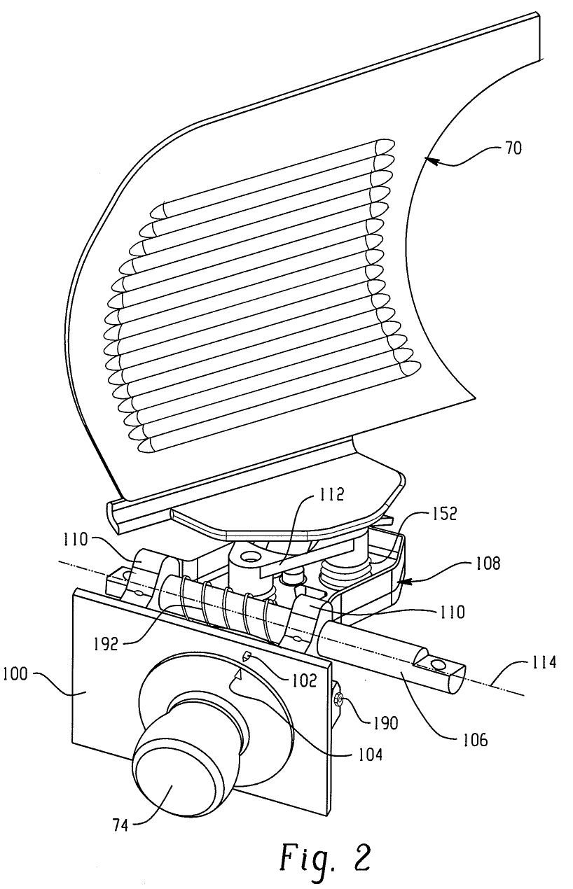

Referring to FIG. 2, where a portion of the slicer housing is shown as 100, a gauge plate system includes rotatable handle assembly with handle 74. The housing 100 includes a zero position indicant 102 and the handle assembly includes a corresponding zero position indicant 104. Though not shown, the handle assembly will typically include other thickness indicants, such a visible numbers and/or a series of hash marks etc. to which an operator can refer when selecting a desired slice thickness. Internal of the slicer a slide rod 106 is fixed to the slicer base (e.g., by fasteners through end openings of the slide rod). An index slider 108 includes mount brackets 110 with openings therethrough enabling the index slider to move along the length of the slide rod 106. The gauge plate 70 is connected to the index slider 108 via an intermediate plate 112. In normal slicer operation the position of the intermediate plate 112 relative to the index slider 108 is fixed. The handle 74 is linked with the index slider 108 such that rotation of the handle 74 causes the index slider to move axially along the slide rod 106. The axis 114 of the slide rod is arranged such that movement of the index slider 108 causes the plane of the gauge plate to move relative to the knife edge cutting plane in a desired manner to adjust slice thickness.

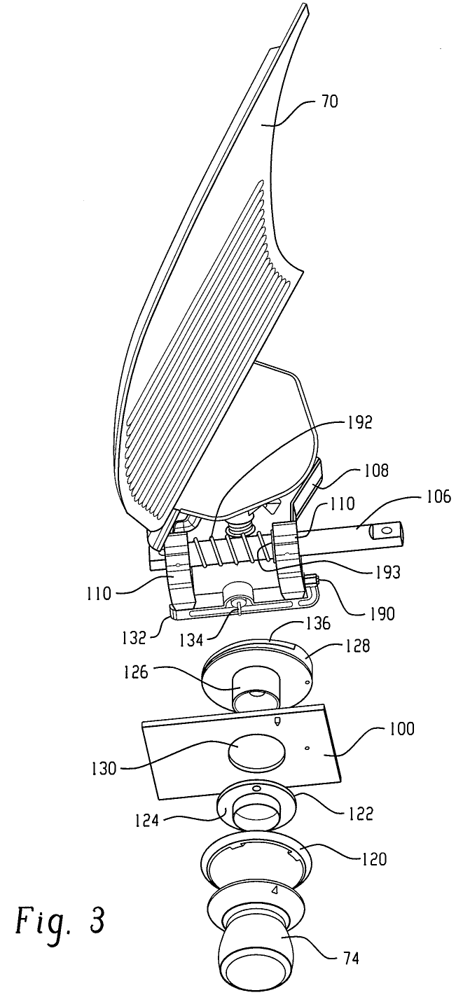

Referring to FIG. 3, the handle assembly includes handle 74, gasket 120 and bearing hub 122. Gasket 120 limits entry of liquids or other material between the inner surface of the handle perimeter and the outer surface of housing portion 100. Bearing hub 100 is fixed to the exterior of the housing portion 100 (e.g., by fasteners) and provides an inner, cylindrical bearing surface 124 for a shaft portion 126 of a cam member 128, which shaft portion 126 projects through opening 130 in the housing portion 100. Cam member 128 is fixed for rotation with the handle 74 via a fastener (not shown) that extends through the cam member 128, the opening 130 and into the interior of the handle 74. In a preferred arrangement the internal structure of the handle member and projecting connection structure of the cam member form a keyed relationship such that the rotational position of the cam member and the indicant scale of the handle is preset to a consistent position from machine to machine. A cam follower bracket 132 is connected to the index slider bearing brackets 110 and includes a cam follower pin 134 extending toward the cam member 128. The follower pin 134 is positioned within a spiraling cam slot 136 of the cam member such that the rotation of the cam member 128 causes the cam follower bracket 132 to move the index slider 108 axially along the slide rod 106, thereby enabling operator adjustment of the gauge plate position.

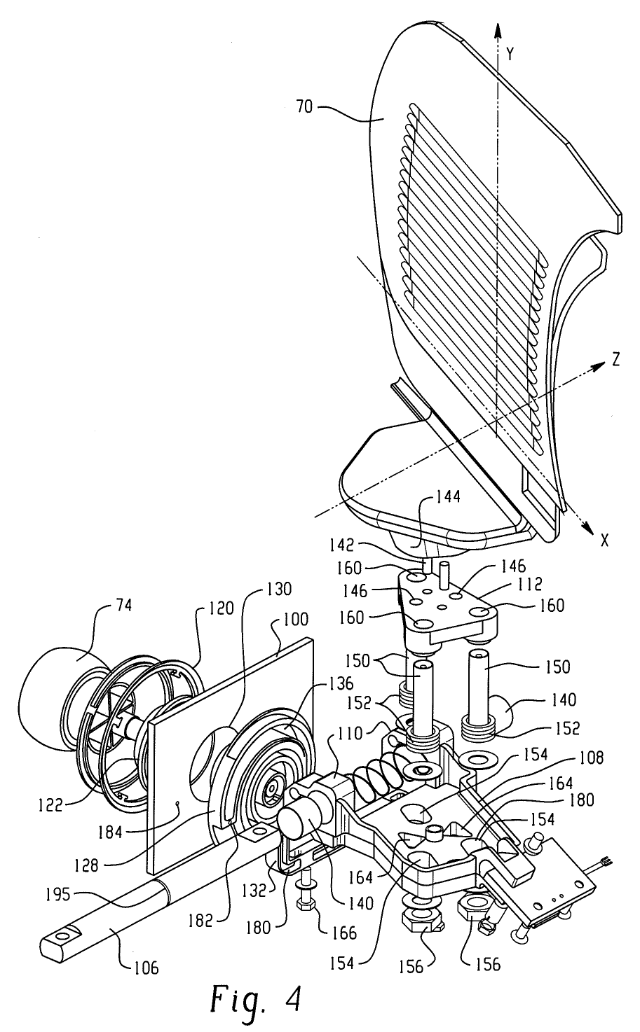

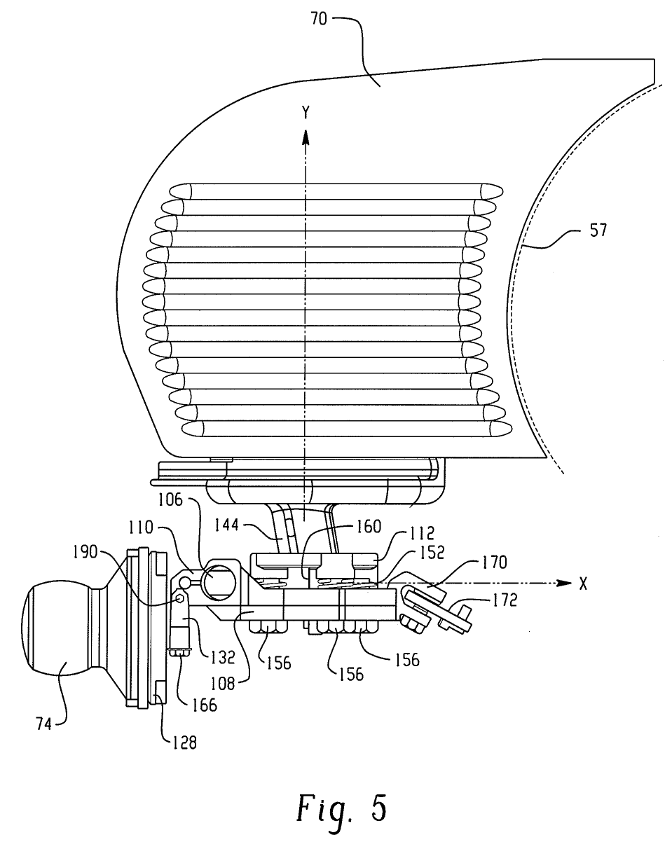

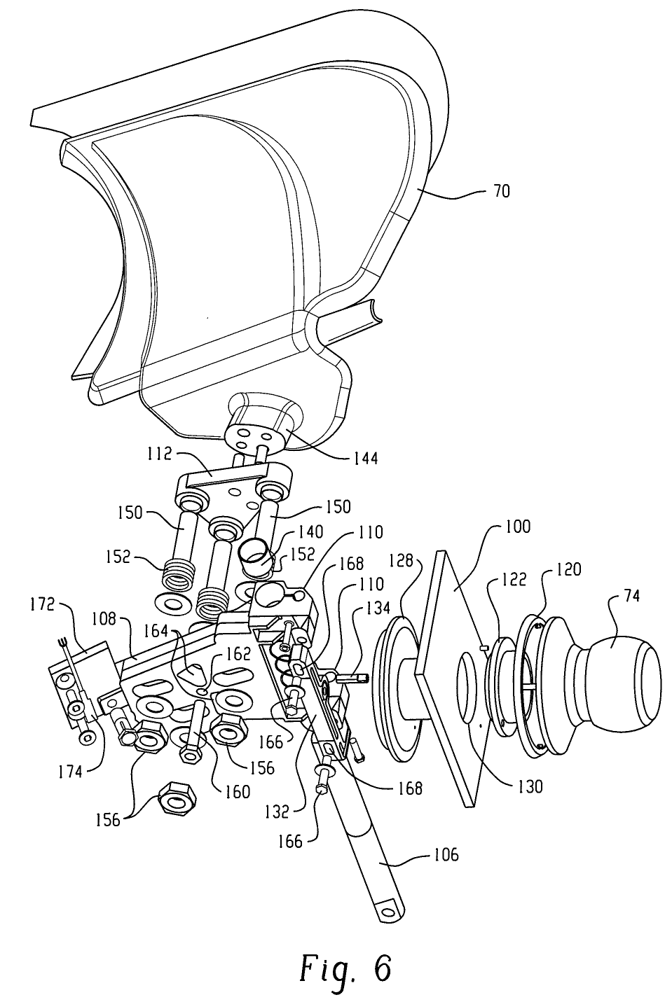

Referring now to FIG. 4, bearings 140 that are seated within slider bearing brackets 110 are shown. Gauge plate 70 is fixed to the intermediate plate 112 via fasteners (not shown) that connect to openings in the bottom of the lower portion 144 of the gauge plate 70 and openings 146 in the intermediate plate 112. Stabilizing pins 142 are also provided. The intermediate plate 112 and index slider 108 have a three point connection formed by posts 150, springs 152, slots 154 and nuts 156. Posts 150 may be connected with plate 112 via fasteners (not shown) that pass downward through plate openings 160 and into openings in the tops of the posts 150. The posts are sized to extend through the slots 154 and the lower ends of the posts are threaded to receive the nuts 156. In assembled form the springs 152 are sandwiched between the plate 112 and index slider 108 (as per FIG. 5) and tend to urge the plate 112 upward away from index slider 108. The position of the plate 112 relative to the index slider is locked into place via a threaded fasteners 160 (FIG. 6) that extends upward through the a threaded opening 162 in the index slider such that the upper end of the fastener 160 contacts the underside of the plate 112 and stabilizes the position of the plate 112. While one stabilizing fastener 160 is shown, multiple such fasteners could be provided. Access to the fasteners connecting the intermediate plate 112 to portion 144 of the gauge plate 70 is provided through openings 164 in the index slider 108. Fasteners 166 used to connect the cam follower bracket 132 to the bearing brackets 110 are also shown in FIG. 6, where the fasteners 166 extend through elongates slots 168 of the cam follower bracket 132.

Referring again to FIG. 5, the index slider is supported at one side by the slide rod (not shown) and at the opposite side by a slotted bracket 170 that rides on a plate 172 that may be fixed to the slicer base. The bearing bracket 170 slides along the plate during gauge plate adjustment. The plate 172 may also include one or more sensors 174 (FIG. 6) thereon for electronically detecting if the gauge plate is in the closed position, if desired.

Positioning of the gauge plate 70 relative a slicer blade is achieved through a multi-step process during slicer assembly. The handle 74 and cam member 128 are connected together such that when the handle 74 is rotated so that the indicants 102 and 104 (FIG. 2) are aligned to define the zero position of the handle, a pin opening 182 (FIG. 4) of the cam member aligns with a pin opening 184 in the slicer housing portion 100. The cam follower bracket 132 is loosely connected with the index slider 108 to allow some relative movement between the two along the elongated fastener slots 168 (FIG. 6). Referring again to FIG. 4, the handle 74 is rotated to the zero position, aligning pin openings 182 and 184, the cam follower bracket 132 is moved to align its pin opening 180 with the pin openings 182 and 184, and a pin member (not shown) is passed through the aligned pin openings 180, 182, and 184 to hold the handle 74, cam member 128 and cam follower bracket 132 in place during setting of the gauge plate position. Thus, the openings 180, 182 and 184 act as a means for holding the handle, cam member and cam follower in respective, set zero positions while the orientation of the gauge plate relative to the knife is set. However, various other structures for holding the handle, cam member and cam follower in the respective, set zero positions could be provided. Moreover, a system could be developed in which the handle, cam member and cam follower are held in respective set positions, other than zero positions, while orientation of the gauge plate relative to the knife is set. For example, such orientation adjustment could be done with the handle always rotated to, and held in place at a number “one” thickness setting, with the cam member and cam follower also held in place at their corresponding “one” positions.

Adjustment of 5 degrees of freedom can then be made via adjustment of the three point connection between the intermediate plate 112 and the index slider, by adjusting the nuts 156. Specifically, and referring to the adjustment axes shown in FIG. 4, the adjustability of the five degrees of freedom is described.

One degree of freedom is linear movement along the y-axis. Tightening of the nuts 156 pulls the intermediate plate 112 toward the index slider, moving the gauge plate down along the y axis. Conversely, loosening of the nuts 156 causes the action of the springs 152 to push the intermediate plate 112 upward along the y-axis.

Another degree of freedom is linear movement along the x-axis. Each of the slots 154 in the index slider 108 is elongated generally in the direction of the x-axis to permit adjustment axially along the x-axis when the nuts 156 are sufficiently loose to permit the static friction force caused by the compressed springs 152 to be overcome.

A further degree of freedom is rotational movement about the y-axis. One slot 154 (in the illustrated embodiment the slot also labeled as slot 180 in FIG. 4) is made sufficiently narrow such that it interacts with the sides of its corresponding post 150 to create a pivot point. The other two slots 154 are slightly wider than their corresponding posts 150 to facilitate pivot of the intermediate plate about the pivot axis defined in opening 180, thus enabling rotational position of the gauge plate about the y-axis to be adjusted.

An additional degree of freedom is rotational movement about the z-axis. By selective tightening and loosening of the nuts 156 of the various post connections in different amounts, rotation of the gauge plate about the z-axis is achieved. For example, by tightening the two right most nuts 156 in the view of FIG. 5, the gauge plate will rotate clockwise about the z-axis, which extends into and out of the page in FIG. 5.

Another degree of freedom is rotational movement about the x-axis. Again, by selective tightening and loosening of the nuts 156 of the various post connections in different amounts, rotation of the gauge plate about the x-axis is achieved. For example, by tightening the most rearwardly locate nut 156 in the view of FIG. 5, the gauge plate will rotate into the page about the x-axis.

It is recognized that adjustment of one degree of freedom may also impact one or more other degrees of freedom, and therefore repeated adjustments may need to be made to obtain the desired position for each of the foregoing five degrees of freedom. Once the desired gauge plate orientation relative to the cutting edge 57 of the slicer knife (shown in dashed line in FIG. 5) is achieved for the five degrees of freedom, the stabilizing fastener or fasteners 160 are tightened so that their upper ends contact the underside of the intermediate plate 112, preventing the plate 112 from overcoming the bias of the springs 152 and moving downward toward the index slider 108. Adjustment along the sixth and final degree of freedom can then be made.

Specifically, linear adjustment along the z-axis can then be made. In this regard, the axis of the slide rod 106 may, preferably, be parallel to the z-axis for this purpose as generally shown in FIG. 4. Referring to 3, the cam follower bracket includes an end opening that receives a set screw 190 that is used to make slight adjustments of the relative position between the cam follower bracket 132 and the index slider 108 along the axis of the slide rod 106. The set screw rotates freely within the end opening of the cam follower bracket and is threaded into a threaded opening in the side of the adjacent mounting bracket 110 of the index slider such that rotation of the set screw 190 in a clockwise direction pulls the index slider 108 to the right in FIG. 3 and rotation of the set screw 190 in the counterclockwise direction pushes the index slider to the left in FIG. 3, thereby making the z-axis adjustment. Such z-axis adjustment is made to place the edge of the gauge plate flush with, or slightly raised (e.g., slightly outward of the page in FIG. 5) relative to the knife edge 57. In a typical slicer, the plane of the gauge plate will be oriented to face to the right and slightly upward when viewed from the front of the slicer (e.g., from the left side in the view of FIG. 1). When the proper z-axis position is achieved, the fasteners 166 (FIGS. 5 and 6) can be fully tightened to lock in the relative position between the index slider 108 and the cam follower bracket 132. The zero orientation of the gauge plate relative to the slicer knife has now been defined. Once the zero orientation has been defined, the pin can be removed from the aligned openings 180, 182 and 184 (FIG. 4) and rotation of the gauge plate handle 74 will thereafter move the gauge plate to vary slice thickness. It is noted that such rotation of the handle 74 causes movement of the gauge plate along the z-axis, however such movement is distinguishable from that caused by the set screw 190 in the set screw adjustment sets the zero orientation of the gauge plate relative to the knife, and handle rotation varies slice thickness by moving the handle out of its zero position.

A spring 192 is disposed on the slide rod 106 in a manner (as by pushing against a ring 193 fixed to a slot 195 (FIG. 4) of the slide rod 106) to urge the index slider 108 to the left along the slide rod as viewed in FIG. 3 such that the cam follower pin will always be biased against the outer wall of the spiraling cam slot, thereby reducing backlash when the rotational direction of the cam member is changed.

One advantage of the above-described system is the repeatability of the zero start position and the repeatability of machine to machine index accuracy. One feature that facilitates such repeatability is that the zero position of the cam follower pin along the cam slot is always set to substantially the same position by locking the cam and cam follower into set positions during the adjustment of the gauge plate orientation. All adjustments are also done internal to the machine base which eliminates external adjustment hardware, facilitating cleaning.

It is to be clearly understood that the above description is intended by way of illustration and example only and is not intended to be taken by way of limitation. Variations are possible. For example, while the use of adjustment posts and nuts are described for the three point connection between the index slider and the intermediate plate, it is recognized that bolts that extend upwardly through the index slider slots into threaded openings in the lower side of the intermediate plate could also be used, and the use of the term “post connections” herein is intended to encompass such a variation. Moreover, as previously noted, the handle, cam and cam follower could be locked into positions other than their zero positions for the purpose of gauge plate adjustment. In such a case a secondary plate with predefined thickness could be set onto the gauge plate and adjustments made so that the secondary plate is brought substantially coplanar to and flush with the plane of the knife edge. Other changes and modifications could also be made.

What is claimed is:

1. A food product slicer, comprising:
a base;
a knife mounted for rotation relative to the base;
a carriage assembly mounted to the base for reciprocal movement back and forth past a cutting edge of the knife;
an adjustable gauge plate mounted for movement between a closed position that prevents slicing and multiple open positions that permit slicing at respective thicknesses;
a handle mounted to the base for changing the gauge plate position, the handle connected to move a cam member internal of the base, the cam member operatively connected to move the gauge plate through a cam follower; and
a gauge plate adjustment system for setting an orientation of the gauge plate relative to the knife when the gauge plate is in the closed position, the system including means for holding the handle, cam member and cam follower in respective, set positions while the orientation of the gauge plate relative to the knife is set.

2. The food product slicer of claim 1 where in the means for holding includes alignable pin openings in each of the base, the cam member and the cam follower.

3. The food product slicer of claim 1 wherein the slicer further includes an index slider mounted for movement along a slide rod, the index slider connected to the cam follower to be moved thereby, the gauge plate adjustment system further includes a multi-point connection assembly between the index slider and the gauge plate, the multi-point connection assembly enabling adjustment of the gauge plate with respect to five of six degrees of freedom, the cam follower connected with the index slider to permit relative adjustment of the position of the cam follower relative to the index slider along the slide rod, such relative adjustment enabling the setting of the gauge plate position with respect to the sixth degree of freedom.

4. The food product slicer of claim 3 where in the multi-point connection includes at least three connection points, each defined by a post connection with a spring compressed between the index slider and an upper intermediate plate to which a lower end of the gauge plate connects.

5. The food product slicer of claim 4 wherein each post connection is adjustable to move a position of the intermediate plate relative to the index slider.

6. The food product slicer of claim 4 further including at least one stabilizing fastener for locking in a relative position between the intermediate plate and the index slider.

7. The food product slicer of claim 1 wherein the respective set positions of the handle, cam and cam follower are respective set zero positions.

8. A method of setting an orientation of a gauge plate of a food product slicer where the food product slicer includes a handle for varying position of the gauge plate relative to a slicer knife to vary slice thickness, the handle linked to the gauge plate through a cam arrangement including a cam member and cam follower, the method comprising the steps of:
moving the cam member to a set position;
locking the cam member into the set position and locking the cam follower into a corresponding set position;
adjusting position of the gauge plate with respect to the slicer knife and relative to six degrees of freedom; and
unlocking the cam member and the cam follower to permit slice thickness adjustment via movement of the cam member.

9. The method of claim 8 wherein the cam member is connected with an adjustment handle used to vary slice thickness, the handle includes a visible slice thickness indicant scale, and the cam member and the handle are connected in a keyed relationship such that orientation of the cam member and the visible slice thickness indicant scale is predefined.

10. The method of claim 8 wherein the adjusting step involves:
adjusting the position of the gauge plate relative to five of the six degrees of freedom;
fixing the position of the gauge plate relative to the five degrees of freedom;
subsequent to the fixing step, adjusting position of the gauge plate relative to the sixth degree of freedom by moving the gauge plate relative to the cam follower while the cam follower remains locked in its set position;
fixing the position of the gauge plate relative to the cam follower when desired position of the gauge plate relative to the sixth degree of freedom is achieved.

11. The method of claim 8 where the locking step involves placing a pin through aligned pin openings in each of the cam follower, the cam member and a base of the slicer.

12. The method of claim 8 wherein the step of adjusting position of the gauge plate relative to five out of six degrees of freedom involves providing a multiple post connections between an index slider that connects to the cam follower and an intermediate plate that connects to the gauge plate, each post connection including a spring compressed between the intermediate plate and the index slider to urge the intermediate plate upward away from the index slider, and varying compression of the springs.

13. The method of claim 12 wherein the step of fixing the position of the gauge plate relative to the five degrees of freedom involves rotating at least one stabilizing fastener into a position to prevent the intermediate plate from moving toward the index slider.
